(19) United States
(12) Patent Application Publication
(10) Pub. No.: US 2004/0199620 A1
(43) Pub. Date: Oct. 7, 2004

(54) Method for transfering a registered domain name from a first registrar to a second registrar

(76) Inventors: Tim Ruiz, Cedar Rapids, IA (US); Brian Richard Krouse, Phoenix, AZ (US)

Correspondence Address: Stewart J. Womack, Go Daddy Software, Inc., Suite 219, 14455 N. Hayden Road, Scottsdale, AZ, 85260, US

(21) Appl. No.: 10/408,037

(22) Filed: Apr. 4, 2003

(51) Int. Cl. G06F 15/173

(52) U.S. Cl. 709/223

(57) ABSTRACT

The present invention allows a Customer to register a domain name with an accredited Registry via an accredited Registrar's web site. Zone files from the Registries may be downloaded, optimized and stored in an internal database. As the Customer selects desired domain names, their availability may be determined by searching the internal database or, if needed, the authoritative Registry. The Customer enters the Customer's information on a registration application displayed as a single form on a single web page. The Customer's information may be saved in a login account for use as default Customer information at subsequent login sessions. The available domain name, Customer information and an associated status flag may be saved to an internal database. Software may be used to monitor the internal database and register all unregistered domain names in the internal database to a Registry's SRS database.

### CROSS REFERENCE TO RELATED PATENT APPLICATIONS

This patent application is related to the following patent applications concurrently filed herewith, all assigned to Parsons Advanced Holdings, Inc.:

U.S. patent application Ser. No. ______, “Method for Gathering Domain Name Registration Information from a Registrant Via a Registrar's Web Site”;

U.S. patent application Ser. No. ______, “Method for Checking the Availability of a Domain Name”; and

U.S. patent application Ser. No. ______, “Method for Registering a Stream of Domain Names Received Via a Registrar's Web Site”.

### FIELD OF THE INVENTION

The present invention relates to systems and processes for a Customer, i.e. a content provider on the internet, to register a domain name from a Registrar's web site thereby allowing access to the Customer's information over an electronic data network such as the Internet or the world wide web (WWW).

### BACKGROUND OF THE INVENTION

The Internet is a worldwide network of computers and computer networks arranged to allow the easy and robust exchange of information between the users of the computers. Hundreds of millions of people around the world have access to computers connected to the Internet via one of the hundreds of Internet Service Providers (ISPs). Content providers place multimedia information, i.e. graphics and sounds, and other forms of data at specific locations on the Internet referred to as web sites that are typically hosted by an ISP. The combination of all the web sites and their corresponding web pages on the Internet is generally known as the world wide web (web or www).

Web sites may be created using HyperText Markup Language (HTML) to generate a standard set of tags that define how the web pages for the web site are to be displayed. Users of the Internet may access content providers' web sites using a software package known as a browser, such as Microsoft Internet Explorer or Netscape Navigator. After the browser has located the desired webpage, it requests and receives information from the web page, typically in the form of an HTML document, and then displays the web page's content for the user. The user may then view other web pages at the same web site or move to an entirely different web site using the browser.

Browsers are able to locate specific web sites because each web site, resource and computer on the Internet has a unique Internet Protocol (IP) address. Each IP address is a 32 bit binary number, but is typically shown in dotted decimal notion, e.g. 192.145.68.112, to improve human readability. However, IP addresses, even in dotted decimal notation, are difficult to remember and use by people. Uniform Resource Locators (hereafter “URL”) are much easier to remember and may be used to point to any computer, directory or file on the Internet. A browser is able to access a web site on the Internet through the use of a URL. The URL may include a Hypertext Transfer Protocol (HTTP) request combined with the web site's internet address, also known as the web site's domain name. An example of a URL with a HTTP request and domain name is:

http://www.companyname.com

In this example, the “http” identifies the URL as a HTTP request and the “www.companyname.com” is the domain name.

Individuals, companies, and other entities who provide content on the web generally want to use their name or one of their trademarks as part of their domain name. Thus, domain names are generally company trademarks, personal names or short phrases concatenated with a top level domain name (TLD) extension (e.g. .com, .net, org, us, .biz, etc.). Domain names created in this fashion are much easier to remember and use than their corresponding IP addresses. The Internet Corporation for Assigned Names & Numbers (ICANN) approves all TLDs and delegates the responsibility to a particular organization (hereinafter Registry) for maintaining an authoritative source for the registered domain names within a TLD and their corresponding IP addresses. For certain TLDs, e.g. .biz, .info, us, the Registry is also the authoritative source for contact information related to the domain name. For other TLDs, e.g. .com, .ws, org, .net, a Registrar is the authoritative source for the contact information related to the domain name. All domain names are organized through a central domain name Shared Registration System (SRS) based on their TLD. There is one organization, or Registry, for each of the ICANN approved TLDs.

A process for registering one's own domain name is illustrated in FIGS. 1 and 2. The communications shown here and in other figures of the drawings are typically communications via the internet, but could be direct LAN or WAN connections, telephone lines, cell phone links, RF or fiber optics connections among others. Customer 20, Registry 22, and Registrar 24 are typically entities having access to computer installations equipped for internet communications.

The process for registering a domain name with a particular Registry 22 allows a Customer 20 to use an ICANN-accredited Registrar 24. For example if John Doe wishes to register the domain name “JohnDoe.com”, John Doe may initially verify whether the desired domain name is or is not available by contacting a Registrar 24. The Customer 20 may make this contact using the Registrar's web page and typing the desired domain name into a field in the Registrar's web page created for this purpose. (Step 30) Upon receiving the request from the Customer 20 (Step 32), the Registrar 24 may ascertain whether “JohnDoe.com” has already been registered by checking the SRS database of the Registry 22 associated with the TLD of the domain name. (Step 34) The results of the search may then be displayed on the web page to thereby notify the Customer 20 of the availability of the domain name. (Step 35) If the domain name is available, the Customer 20 may proceed with the registration process. Otherwise, the Customer 20 will have to keep selecting alternative domain names until an available domain name is found.

Regardless of the Registrar 24 used to process the registration, the Customer 20 must (together with payment of the Registrar's applicable fees), provide certain personal information in order to complete the registration. (Step 36) The registration information typically includes the Customer's address and personal contact information, including an email address, phone number and mailing addresses of an administrative, a technical and a billing contact. The Registrar 24 stores the Customer's contact information and domain name in a temporary, working contact table 50. (Step 38) The registration processes may be very difficult and time consuming for the Customer 20. For example, in a conventional registration process, the Customer 20 is expected to navigate and insert information in several different forms, located on several different web pages on the Registrar's web site. The information may include not only the Customer 20, administrative, technical and billing contact information, but also information regarding additional services offered by the Registrar 24. The additional services may include the option of a proxy service or other domain name service setup features, e.g. providing hosting services, for sale page, web site creation, or forwarding and masking for the domain name. Entering the information on several different forms residing on several different web pages can become confusing and laborious for the Customer 20. This problem is compounded if the Customer 20 is registering multiple domain names with the Registrar 24 and must complete this process for each domain name. A Customer 20 may wish to return to the Registrar's web site many times to register additional domain names or to select different proxy services or to enter different domain name service setup information. The registration process may therefore need to be repeated many times by the same Customer 20 who has to retype much of the same information at each login session.

After the Customer 20 submits the registration request, the Registrar 24 transmits certain information to the Registry 22 regarding both the Registrar 24 and the Customer 20, who will, upon completion of the registration process, be identified as the “registrant”of the domain that is now officially registered with the Registry 22. (Step 40) The Registry 22 adds the domain name, the registrant's name and identification of the Registrar 24 (Step 23) to the SRS database 23 kept by the Registry 22, which then becomes publicly available in the Registry WHOIS (Step 42) The authoritative contact information is stored with the Registry 22 for the so called “thick registries”, e.g. .biz, .info and us, and with the Registrar 24 for the so called “thin registries”, e.g. .com, .ws, org and net. (Steps 48 and 50) The Registry 22 confirms the registration to the Registrar 24. (Step 46) The registration process is concluded by the Registrar 24 confirming the registration to the Customer 20. (Steps 52 and 54).

Applicants have noticed that having the Registrar 24 contact the appropriate Registry 22 to determine if a domain name is available and to have the Registrar 24 contact the appropriate Registry 22 to register a single domain are very inefficient processes. The piece meal process of the prior is very inefficient in terms of hardware and internet connection use. A connection must be made and appropriate handshaking must be completed to verify the identity of the Registry 22 and Registrar 24 for a secure transaction each time data is exchanged between the Registrar 24 and the Registry 22. The repeated processes of checking the availability of domain names and registering one or even just a few domain names with the Registry 22 is very inefficient due to the overhead associated with each contact and puts a heavy demand on the hardware requirements for both the Registrar 24 and the Registry 22.

To continue to meet the demands of Customers 20 registering domain names with a Registry 22, new systems and processes will be needed to overcome the limitations of current methods. Thus, there remains a need for systems and methods which reduce or eliminate the problems associated with the conventional methods. Specifically, there is a need for simplifying the process for checking the availability of a domain name and the registration process of a domain name, particularly for Customers 20 that register multiple domain names over a single or multiple login sessions. There is also a need for a system and process for increasing the efficiency of transferring data from the Registrar 24 to one or more Registries 22. There is also a need for being able to transfer sponsorship of a domain name from a first Registrar to a second Registrar.

### SUMMARY OF THE INVENTION

The present invention addresses these needs by providing improved systems and processes for registering domain names with an accredited Registry via an accredited Registrar. A Customer, i.e. a registrant, may visit a Registrar's web site using one of the many widely available browsers. The Registrar's web site allows the Customer to enter a desired domain name and the components or services, i.e. automated software processes, of the website automatically check on the availability of the domain name.

Zone files, containing all the registered domain names with their corresponding web sites, may be periodically downloaded from the Registries. The zone file information may be parsed to find the registered domain names which may then be stored in an internal database in an optimized format. Searches on the optimized internal database are much faster than prior art searches of a Registry for a domain name. Domain names found in the optimized internal database are determined to be not available (typically the most common result), while domain names not found in the internal database may be subjected to an additional search at the appropriate Registry. The Registry needs to be searched when the domain name is not found in the internal database to allow for the possibility that the domain name may have been registered after the zone files were downloaded.

The availability of the desired domain name may then be displayed to the Customer using a field on a web page designed for that purpose. Available similar domain names may also be displayed to the Customer and the Customer may select one of the displayed domain names for registration. The process of entering a desired domain name and displaying the availability of the desired domain name, as well as displaying other suggested similar domain names, may be repeated until at least one domain name has been selected for registration by the Customer.

The Customer's contact information is preferably obtained from a contact information section on a registration application. The registration application may advantageously comprise a single form residing on a single web page. The contact information may include information that may also be used as registrant contact information, technical contact information and administration contact information when a selected domain name is registered with a Registry.

The registration application may also include a registration type section. The registration type section allows the Customer to select the option of having a proxy registration, whereby a Proxy's information is sent to the Registry and stored in the WHOIS database in place of the Customer's contact information. In this case, the Proxy is the legal owner of the domain name, but may lease the domain name to the Customer. The registration application may also include a domain name service setup section. The domain name setup section allows the Customer to specify additional features or services provided by the Registrar, e.g. hosting or web page options for the domain name.

The components or services of the Registrar's web site may register the domain name with a Registry. In a preferred embodiment, the selected domain name and Customer information are stored in an Internal Database of the Registrar. The Customer information includes the information received on the registration application and possibly information received from other web pages on the Registrar's web site. A status flag may be set in the Internal Database to indicate that the domain name needs to be registered with a Registry. Services may be used to monitor the Internal Database searching for status flags indicating whether an action is required. The status flag may signal if a domain name needs further processing and if so, what processing step is needed next. The status flag may be continually updated during the registration process to keep track of the domain name's status, via a plurality of services that register the domain name with a Registry.

Communications between the Registrar and each of the Registries may be handled by a Hub Service. There is preferably at least one Hub Service dedicated to each Registry assigned to a TLD registered by the Registrar. A Hub Service improves the communications between the Registrar and Registries by attempting to keep open one or more secure connections, typically a Secure Socket Layer (SSL) connection, open to each Registry. This eliminates the time necessary to make the connection when the Registrar and Registries need to exchange information.

In a preferred embodiment, the Customer has the option of creating a login account with the Registrar's web site. The Customer may type in a login name and a password to create the login account. Once created, the login account may store information in an internal database regarding the Customer that may be used in subsequent login sessions as the default information for the Customer. The stored information may, for example, include contact information (such as the name and address of the Customer), registration type, domain name service setup information and/or preferred payment method (such as information from a credit card).

A Customer may elect to transfer a domain name sponsored by a First Registrar to a Second Registrar. The Customer enters registration information which is stored in an internal database along with an appropriately set status flag. The Customer's registration information may be compared to information from an authoritative source to verify the Customer's right to transfer the domain name. The authoritative source will either be the registry for the TLD or the current sponsoring Registrar, depending on the ICANN rules for that TLD. If the information does not match, the Customer may be notified of the mismatch and is not permitted to transfer the domain name. If the information does match, a confirmation email may be sent to the email address of the administrator found in the authoritative source. The email may have a key to permit the transfer and the email may provide a link to a secure area controlled by the Registrar. The administrator, having received the confirmation email, may connect to the secure area and either allow or prevent the domain name from being transferred from a First Registrar to a Second Registrar.

Additional advantages and aspects of the present invention will become apparent in the following detailed description and claims.

### BRIEF DESCRIPTION OF THE DRAWINGS

FIG. 1 is a block diagram illustrating the relationship between the participants in a prior art domain name registration process;

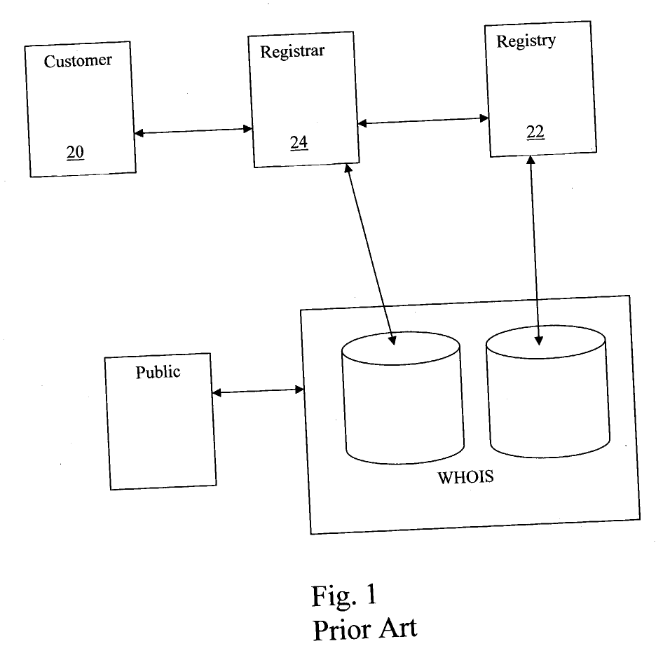

FIG. 2 is a functional block diagram in flowchart form illustrating the method of domain name registration typically employed in a prior art registration process;

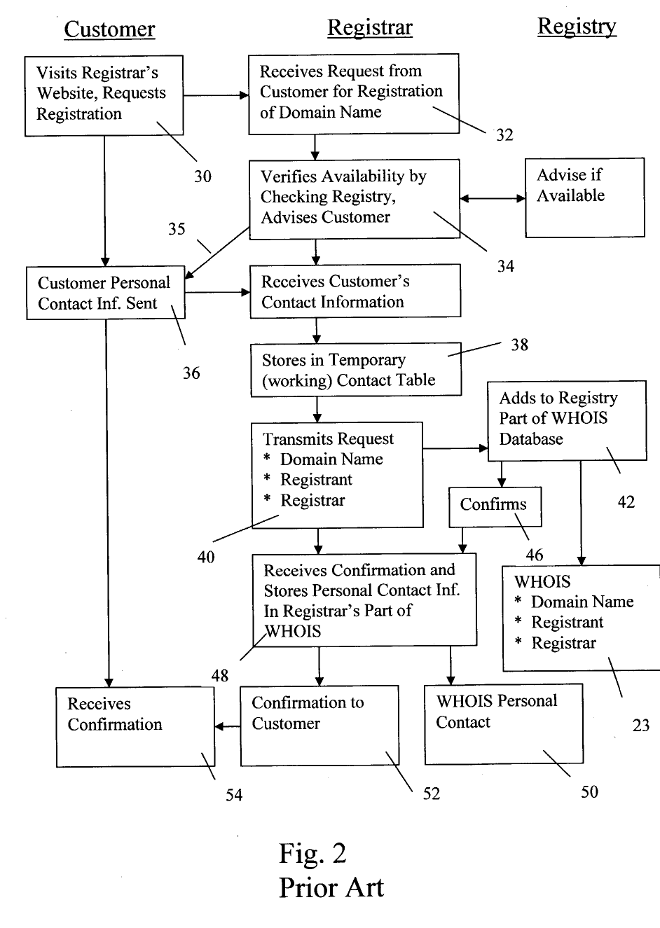

FIG. 3 is a functional block diagram in flowchart form illustrating a domain name registration process according to an embodiment of the present invention;

FIG. 4 is a printed copy of a web page by which a Customer may enter a desired domain name;

FIG. 5 is a printed copy of a web page by which a Customer may enter data into a registration application includes a single form residing on a single web page;

FIG. 6 is a block diagram illustrating the participants in a domain name registration according to one embodiment of this invention;

FIG. 7 is a block diagram illustrating a process for checking on the availability of one or more domain names;

FIG. 8 is a block diagram illustrating a process for transferring the registration from one Registrar to another Registrar;

FIG. 9 is a table illustrating various statuses that a domain name may have during processing and example corresponding values for flag statuses;

FIG. 10 is a flowchart illustrating a process for checking the availability of a domain name; and

FIG. 11 is a flowchart illustrating a process for transferring a domain name from a first Registrar to a second Registrar.

### DETAILED DESCRIPTION OF THE PREFERRED EMBODIMENTS

The present invention will now be discussed in detail with regard to the attached drawing figures which were briefly described above. In the following description, numerous specific details are set forth illustrating Applicants' best mode for practicing the invention and for enabling one of ordinary skill in the art to make and use the invention. It will be obvious, however, to one skilled in the art that the present invention may be practiced without many of these specific details. In other instances, well-known machines and process steps have not been described in particular detail in order to avoid unnecessarily obscuring the present invention. Unless otherwise indicated, like parts and processes are referred to with like reference numerals.

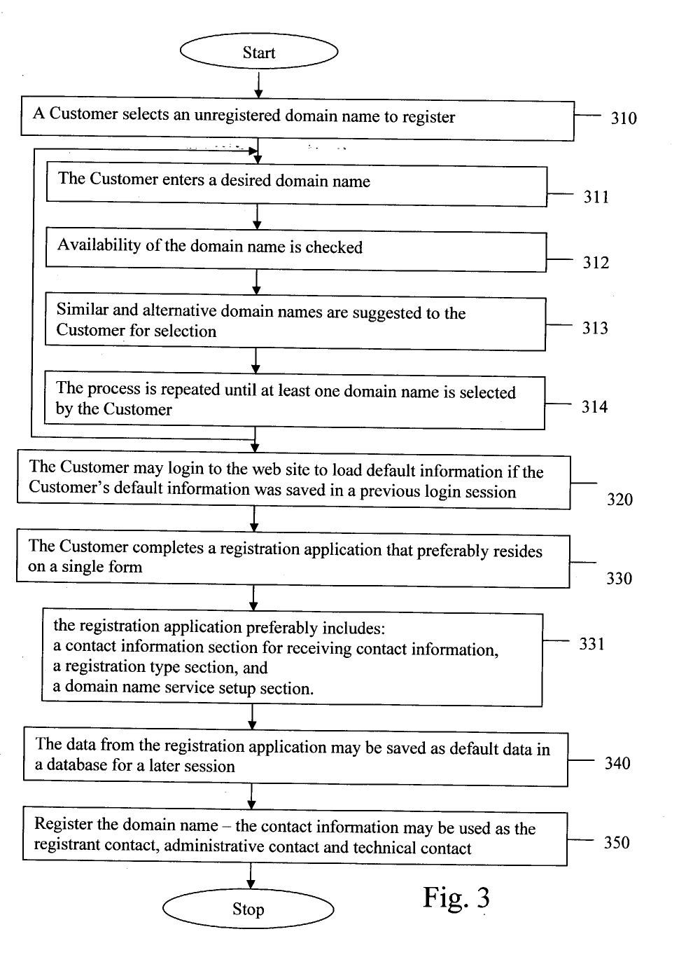

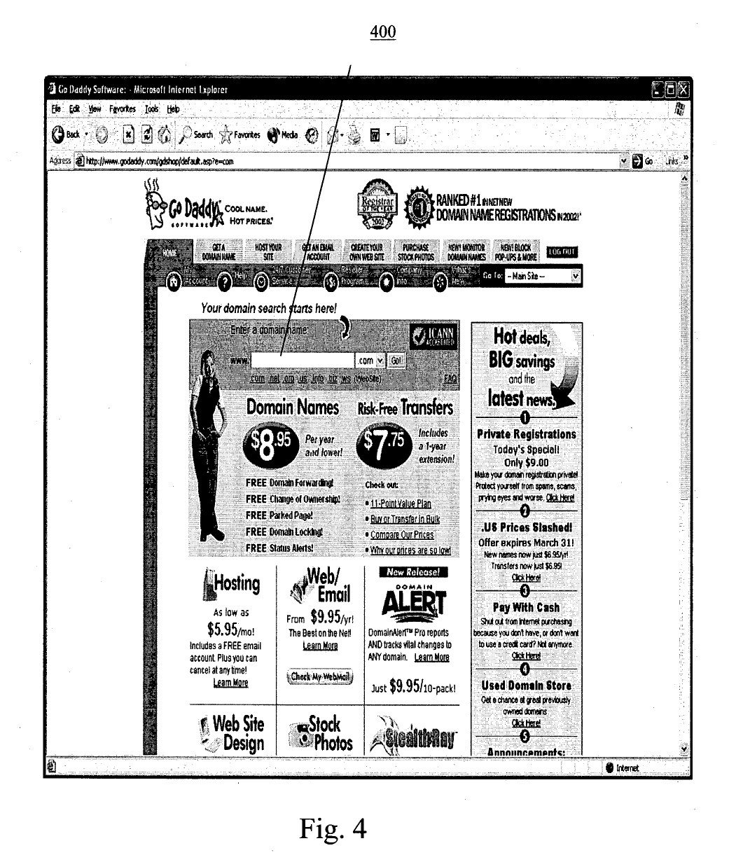

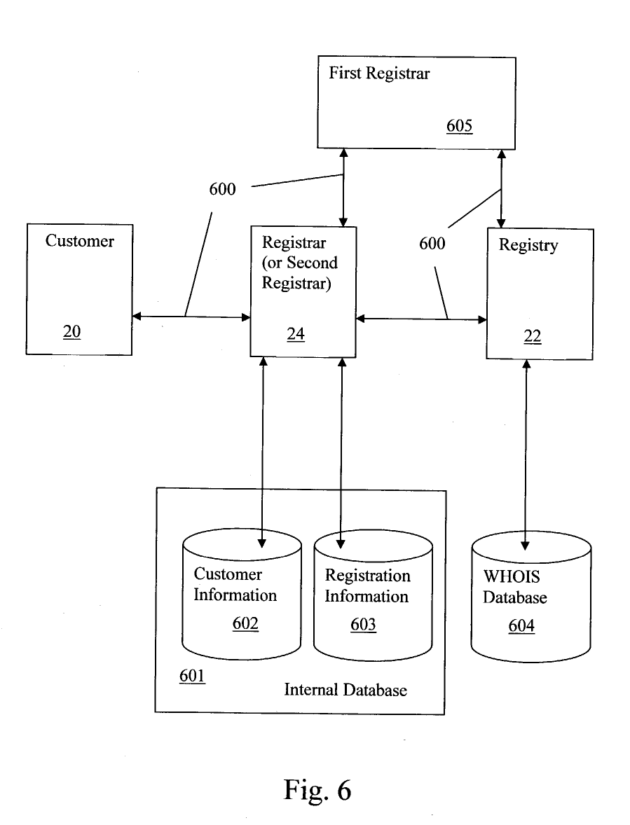

Referring to FIG. 6, the present invention allows a Customer 20 to register one or more domain names over the Internet 600 via a Registrar 24. The process may be started by the Customer 20 accessing a web site belonging to an ICANN-accredited Registrar 24 using a commercially available web page browser. A system and process for the Customer 20 to register one or more domain names at a Registrar's web site will be discussed with reference to the flowchart in FIG. 3. FIG. 4 illustrates an example of a web page from a web site belonging to a Registrar 24, in this case Go Daddy Software®.

A domain name registration process may be initiated by a Customer 20 entering a desired domain name in a field 400 on a web page. (Step 311). The components, i.e. web site software for automatically processing data entered into the web site, may check on the availability of the desired domain name entered by the Customer 20. (Step 312).

Process for Checking on the Availability of a Domain Name

One method for checking the availability of domain names involves querying the appropriate Registry 22 SRS assigned to the selected TLD. If the Registry SRS acknowledges the existence of the domain name, then the domain name is considered to be not available, otherwise the domain name may be registered. This method has the advantage of always using the most up-to-date information since the Registry 22 is the authoritative source for domain name registration, but has the disadvantage of having to contact a Registry 22 via the Internet each time the availability of a domain name is checked.

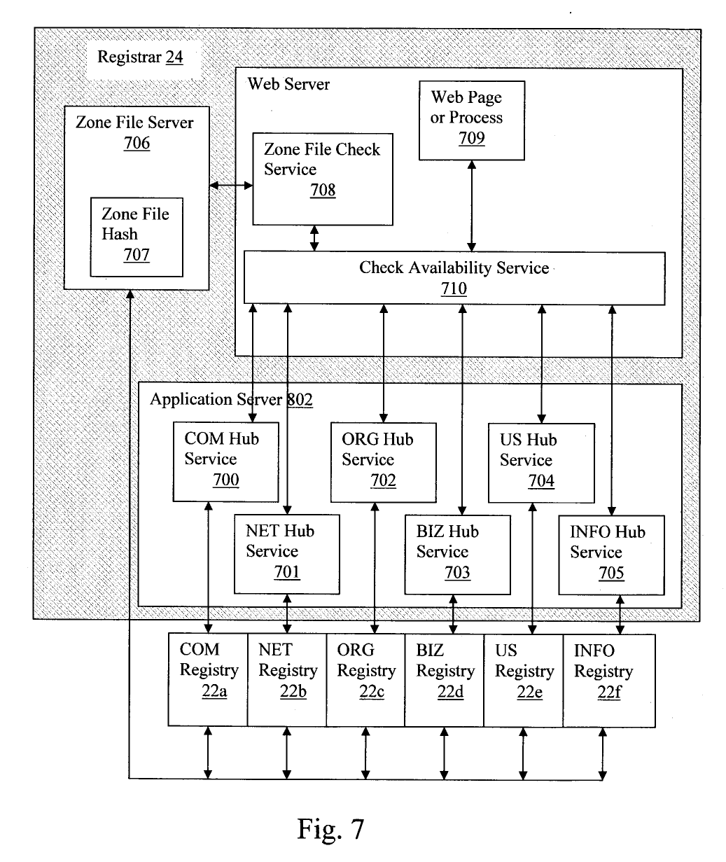

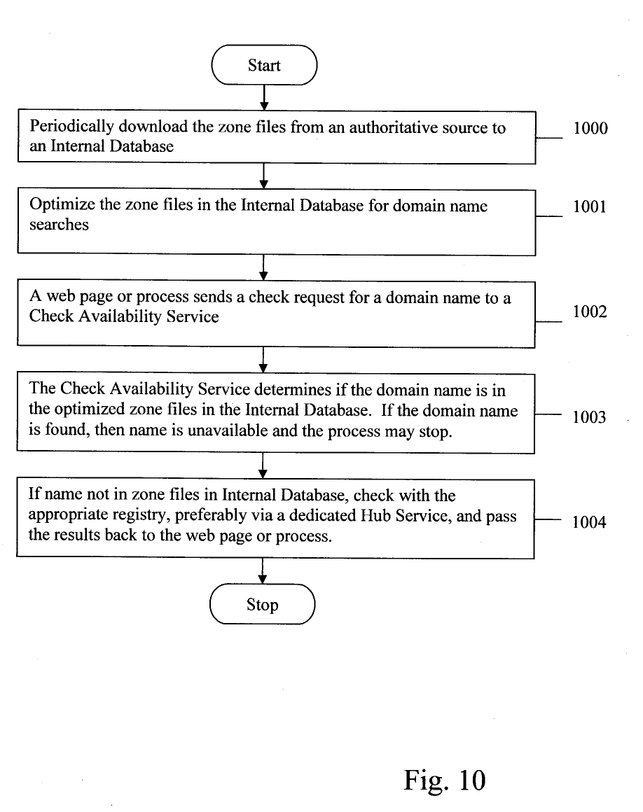

A preferred method for checking the availability of domain names is illustrated in the block diagram of FIG. 7 and the flowchart in FIG. 10. A Zone File Server 706 may be updated, preferably about once every 24 hours, by an automated process that downloads the zone files from each of the Registries 22a-f. (Step 1000) The zone files may be received from the Registries 22a-f using known methods of transferring data, such as by File Transfer Protocol (FTP). Downloading the zone files brings the zone file's data into an internal database which greatly reduces access time to the zone file data.

The zone files from the registries 22a-f are preferably optimized for domain name searches and stored on the Zone File Server 706. (Step 1001) One method for optimizing the zone files involves parsing the zone files and extracting the domain names thereby creating a compressed Zone File Hash 707. The Zone File Hash 707 may be queried for domain name availability much faster than sending queries over the Internet to the non-optimized data of the Registries 22a-f.

A web page or other process 709 may send a domain name check request to a computer automated process, such as a Check Availability Service 710. (Step 1002) There is preferably at least one Check Availability Service 710 on every web server where availability checks may need to be performed. The Check Availability Service 710 may receive availability check requests for all TLDs and also for nameservers.

The Check Availability Service 710 preferably first checks for the availability of the domain name by sending the request to another computer automated process, such as a Zone File Check Service 708. The Zone File Check Service 708 may be used to provide connections and manages availability check requests targeted to the Zone File Server 706. There is preferably at least one Zone File Check Service 708 on every web server where availability checks need to be performed. The Zone File Check Service 708 may receive availability check requests for all TLDs and nameservers.

The Zone File Check Service 708 may query the Zone File Server 706 and receive a response indicating if the desired domain name was found in the Zone File Hash 707. The results of the domain name search may be returned to the Check Availability Service 710. (Step 1003) If the domain name was in the Zone File Hash 707, then the domain name is considered not available. This process is typically very efficient since the Zone File Hash 707 is an internal database on the Zone File Server 706 with data in an optimized format for searching. Applicants have noticed that desired domain name searches typically yield the result that the domain name has already been registered. Thus, this process quickly leads to a final determination in many cases.

If the domain name was not in the Zone File Hash 707, a request may then be sent to the Registry 22a-f responsible for the domain name's TLD to check the availability of the domain name. (Step 1004) This is necessary since the domain name may have been registered after the last update of the Zone File Hash 707 in the Zone File Server 706. The Registry's 22a-f response is considered authoritative and is passed back to the requesting web page or other process 709.

The Registrar's Check Availability Service 710 preferably communicates to the Registries 22a-f via one or more Hub Services 700-705. The Hub Services 700-705 maintain and manage connections from the Check Availability Service 710 to the Registries 22a-f, typically via a secure socket layer (SSL) connection. There is preferably at least one Hub Service for every TLD used. The Hub Services 700-705 may reside on the Application Server 802. Each Registry 22a-f allows a certain number of guaranteed connections to a Registrar 24. In addition, some Registries 22a-f offer more connections on a first-come-first-served basis. The Hub Services 700-705 keep open connections to the Registries 22a-f thereby greatly decreasing access times and improving the efficiency of the domain name registration process. In a preferred embodiment, each Hub Service 700-705 is a dedicated centralized connection management system optimized to maintain an Internet connection with a corresponding Registry 22a-f.

It should be noted that while FIG. 7 illustrates a six Hub Services 700-705 system maintaining connections with six Registries 22a-f, one of ordinary skill in the art will recognize that any number of Registries and corresponding Hub Services may be used in combination with the present invention.

Process for Providing Suggested Domain Names

The Registrar's web site may also generate additional similar domain names and, if the generated domain names are determined to be available, display the available alternative domain names to the Customer 20. The similar domain names may be generated by replacing the desired TLD with one of the other possible TLDs, by replacing the non-TLD portion of the domain name with a synonym or by concatenating a short word, preferably one that has been found to be popular among domain name registrants, as a prefix or suffix to the non-TLD portion. (Step 313).

The process of receiving desired domain names from the Customer 20, generating similar domain names and checking and displaying the availability of the domain names may be repeated as many times as desired by the Customer 20. In this manner, the Customer 20 may select for registration one or more available domain names. (Steps 310 and 314).

Process for Gathering Domain Name Registration Information

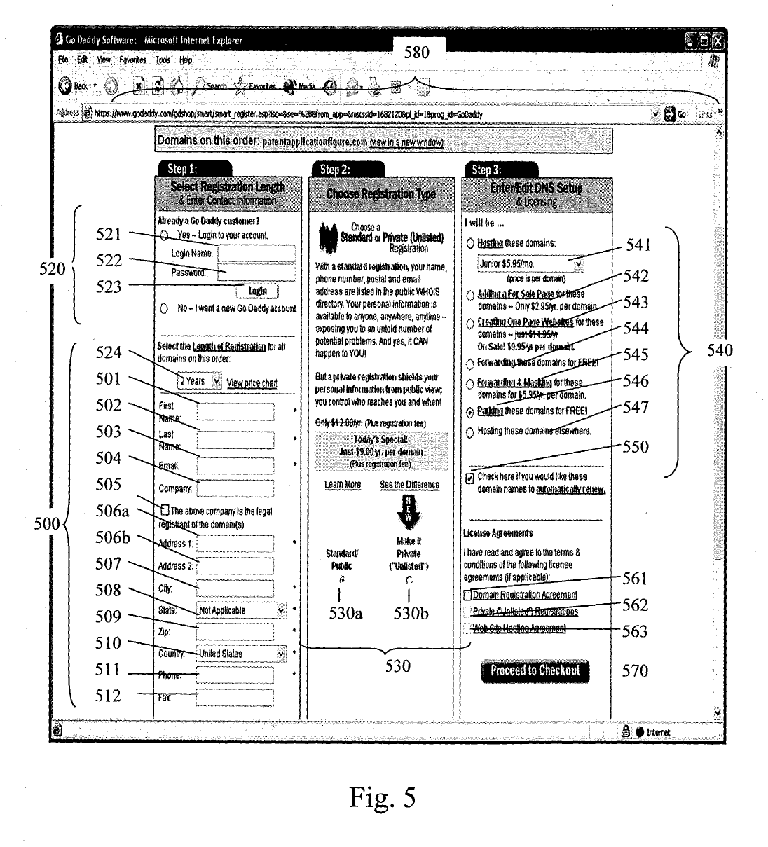

The registration of an available domain name requires the Customer 20 to provide the Registrar 24 with a substantial amount of information, typically by typing the information into fields in a web page designed for this purpose. The information allows the Registrar 24 to register the domain name with a Registry 22 and allows the Customer 20 to select desired products or services for the newly registered domain name. FIG. 5 illustrates a registration application 580 designed to receive all or a substantial portion of this information.

A Customer 20 who has previously created a login account on the Registrar's web site may wish to login to their account so that their customer information 602 stored in an internal database 601 previously entered may be used as their default information for the current login session. A login section 520 is illustrated in registration application 580. The login section 520 may have a field 521 for receiving a login name and a field 522 for receiving a password previously selected by the Customer 20. After entering a login name and a password, the Customer may attempt to login by selecting the login button 523. If the password corresponds to the login name from a previously created login account, default customer information 602 may be loaded from the Registrar's internal database 601 into the corresponding fields in the registration application 580. (Step 320).

Storing customer information 602 received from previous login sessions typically simplifies the process of entering customer information 601, since Applicants have noticed that Customers 20 tends to repeat the same information and select the same options for each domain name they subsequently register. If this is the Customer's 20 first time registering a domain name with the Registrar 24, or if the Customer 20 did not create a login account at a previous login session, the Customer 20 will have to enter the information into the registration application 580.

The registration application 580 preferably comprises a single form that resides on a single web page. (Step 330) The registration application 580 may include a contact information section 500, a registration type section 530 and a domain name service setup section 540. (Step 331) It should be noted that additional fields may be used for entering information for other options or services related to the domain name. As examples, a field for selecting a length of registration 524, a field for selecting an automatic renewal option 550 and fields for acknowledging reading and agreeing to the terms and conditions of one or more license agreements 561, 562 and 563 may also be placed on the registration application 580.

The contact information section 500 may include a plurality of fields for entering the Customer's contact information. The contact information section 500 may include fields for a first name 501, a last name 502, an email address 503, a company name 504, a company name is the legal registrant 505 verification, an address 1506a, an address 2506b, a city 507, a state 508, a zip code 509, a country 510, a phone number 511 and a fax number 512 for the Customer 20, as examples.

The ICANN approved registration process for a domain name requires information for a registrant contact, a technical contact and an administrative contact to be stored and made publicly available. This information is stored in a Registry's WHOIS database 604 for the so-called “thick” registries, e.g. Registries 22 handling TLDs of .biz, .info and .us, and is stored in a Registrar's WHOIS database for the so-called “thin” registries, e.g. Registries 22 handling TLDs of .com, .ws, .org, and .net. In a preferred embodiment of this invention, the contact information from the contact information section 500 is used as the registrant contact information, the technical contact information and the administrative contact information. The contact information may also be used as billing contact information.

Applicants have discovered that Customers 20 generally use the same contact information for the registrant contact information, the technical contact information, the administrative contact information and the billing contact information. Using the contact information for all the different necessary contact information simplifies the domain name registration process for the majority of the Customers 20. A single form registration process has the advantage that the Customer 20 is more likely to complete a single-page form and thus more likely to register a domain name through the Registrar 24. A multi-step process is more likely to discourage and deter Customers 20 from completing the registration process. A single-page form registration process is also less expensive to implement technically, since it requires far fewer round trips between client and server, thus reducing costs associated with bandwidth consumption and CPU usage.

A registration application 580 may also include a registration type section 530. The registration type section 530 may include fields to select a standard/public registration 530a or a private/proxy 530b registration. The standard/public registration stores the Customer's contact information in a publicly available WHOIS database, managed by either a Registry 22 or Registrar 24. The private/proxy registration stores a Proxy's contact information in the WHOIS database thereby shielding the Customer's contact information from public view. The Proxy is the legal owner of the domain name, but may lease the domain name back to the Customer. Shielding the Customer's contact information in this manner may be beneficial to the Customer 20 to stop domain name related spam, deter identity theft and fraud, prevent harassers, stalkers and data miners, protect a second web identity or allow a home business to be run without unwarranted intrusions.

A registration application 580 may also include a domain name service setup section 540. This section is preferably used to allow the Customer 20 to select one or more options or additional services for the selected domain name(s). In a preferred embodiment, the domain name service setup section 540 has fields for entering data related to hosting a web site for the domain name 541, adding a for sale page for the domain name 542, creating a one page website for the domain name 543, forwarding the domain name 544, forwarding and masking the domain name 545, parking the domain name 546 and hosting the domain name elsewhere 547. It should be noted that additional options or services may be added or one or more of the listed options or additional services may be removed without departing from the scope or spirit of the present invention.

The Customer 20 may create a login account to store the customer information 602 in a Registrar's Internal Database 601. (Step 340) The Customer information 602 will preferably include the above described information from the registration application 580 and may also include information gathered on other web pages. For example, another web page may be used to collect a preferred payment option such as payment via a credit card. In such a case, the credit card number, expiration date and name on the credit card may be stored in the Internal Database 601 as Customer information 602. This allows the Customer information 602 to be used as default information at subsequent login sessions so that the Customer 20 does not have to reenter this information each time the Customer 20 registers a new domain name.

Process for Registering the Selected Domain Name

After the Customer 20 has selected an available desired domain name and provided the registration information, the Registrar 24 may start a process to register a selected domain name with the Registry 22 responsible for the domain name's TLD. An automated computer process (hereinafter “SmartCart”), may be called to perform some of the initial steps. SmartCart may be used to validate all the registration information that was gathered from the Customer 20 and to verify that the information constitutes a complete and valid domain name request. A complete and valid domain name request may include all the required contact information, acceptance of the licensing agreements and nameserver information provided either explicitly or via a selected setup option, e.g., hosting, parking, etc. SmartCart may write to the Internal Database 601 all the information provided to the Registrar 24 by the Customer 20 regarding the domain name registration, including registration length, contact information, license agreement information, and nameserver information. SmartCart may also return to the calling application a well-ordered set of data that may be processed through another automated computer process (hereinafter “Shopping Cart”) in order to proceed with the registration. This well-ordered data may include a domain name product for every domain name requested and may additionally include forwarding products, hosting products, masking products, for sale page products, and 1-page website products, depending on the options selected by the Customer 20.

The advantages of using SmartCart may not necessarily be obvious to the Customer 20 as they primarily benefit software developers who write the applications that process the Customers' domain name requests. SmartCart returns a final confirmation that the requested registration is valid and complete, or conversely, that the registration cannot be completed as submitted. The developer does not have to handle any interactions with an internal database. In the prior art, a developer may have had to call an internal database several times to write domain name registration information to the internal database and several more times to retrieve all the information necessary to process the request through the Shopping Cart.

SmartCart manages the nameserver information that needs to be recorded in the Internal Database 601 and at the Registry 22 in order to implement the Customer's selected setup options, thereby removing this burden from the developer. The developer does not have to figure out what Shopping Cart items need to be processed in order to implement the Customer's setup options. For example, if the Customer 20 chooses to host the domain with the Registrar 24, the Customer 20 may, for example, get a free webmail account as well. The developer doesn't need to take that into consideration. SmartCart may be setup to know what products should be applied to each request and provides all that information to the developer who simply sends it to the Shopping Cart for processing.

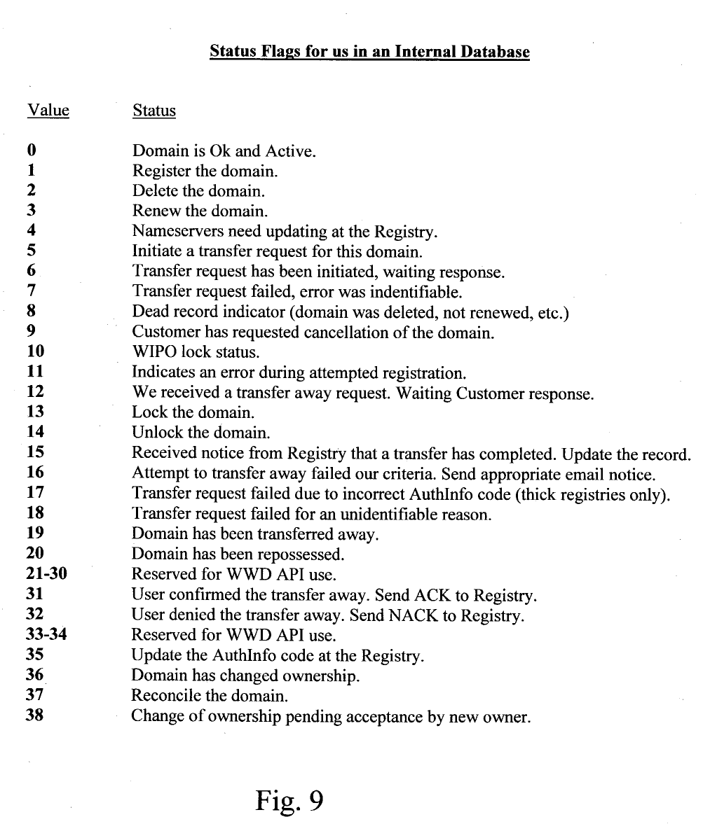

Once the purchase is complete, a post-purchase process may be used to move the registrant information 603 and a corresponding status flag into the Internal Database 601. FIG. 9 shows an example of a list of possible status flags with a value corresponding to a particular status for each status flag. The particular value for each status may be arbitrarily assigned although each flag should have a unique value and once the value has been selected should be consistently used. In addition, not all of the statuses shown in FIG. 9 have to be used and other statuses may be added without necessarily departing from the scope of the invention. Only the status of the status flag, and not the corresponding value of the status flag that is actually stored in the internal database, will be given in the following description of the registration process.

A status flag indicating that the domain name needs to be registered may be initially stored in the Internal Database 601 after the domain name has been selected for registration by a Customer 20. One or more Agent Services 803-805, i.e. computer programs or threads, may be used to monitor the Internal Database 601 and the stored status flags. In a preferred embodiment, there is at least one Agent Service dedicated for processing each TLD handled by the Registrar 24. When an Agent Service 803-805 detects a status flag indicating that a domain name needs to be registered, the Agent Service 803-805 may send a registration request to the Registry 22a-f. The Agent Service 803-805 may make a connection to the Registry 22a-f through the Hub Service 700-705 that manages the connections to that Registry 22a-f for that particular TLD.

There may be a brief intermediate status, for example if a nameserver needs updating at the Registry, after a successful registration. The Agent Service 803-805 may then pick this status up and, depending on the TLD, have other tasks to complete before setting the status to indicate that the domain name is active. This prevents the Customer 20 from getting access to the domain name before the Registrar 24 can be sure everything is set up correctly and allows the Registrar 24 to send only the minimum required information to the Registry 22a-f to get the registration in place quickly. After the domain name has been successfully registered, an email may be sent to the Customer 20 notifying the Customer 20 that the domain name is now registered and that the Customer 20 may use the domain name.

If the registration request to the Registry 22a-f is not successful, the status flag is changed to indicate an error with an appropriate description. An email may be sent to the Customer 20 notifying the Customer 20 that the domain name was not successfully registered. There are preferably both automatic and manual processes in place to try to resolve error statuses and to register the domain name despite the initial failure. For example, a Network Operations Center may try to reregister the domain name every four hours for a certain period of time. This may resolve the problem if the Registry 22a-f happened to have a problem during the initial registration try, but the Registry 22a-f was able to fix their problem in time for a subsequent registration attempt. In addition, one or more people may periodically manually review every error status to determine the cause of the error and, if possible, correct the error so that the domain name may be registered to the Customer 20.

Process for Modifying a Previously Registered Domain Name

After a domain name has been registered, a Customer 20 may request a modification to the services or information associated with their registered domain name. The modifications may be, for example, to change the contact data, change the renewal requests, change the nameservers, etc. Each type of change request has its own status flag value so the Agent Service 803-805 knows which tasks to be performed for each modification requested by the Customer 20. Requested change information, an associated record ID and a status flag may be stored in the Internal Database 601. This allows an Agent Service 803-805 to detect the change request status of the domain name via the status flag and make the requested changes, communicate any necessary change information to the Registry 22 and note any errors in the Internal Database 601. There may be manual and automatic processes in place to deal with the various errors that can occur. An email indicating success or failure may be sent to the Customer 20 regarding the requested change.

Process for Transferring a Domain Name from a First Registrar to a Second Registrar

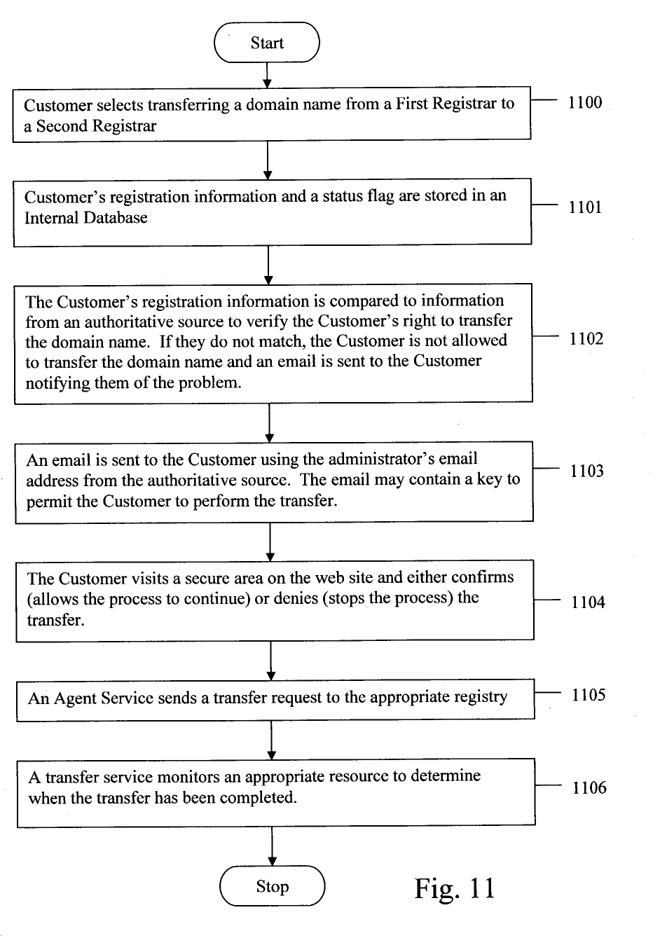

FIG. 11 shows a possible method for transferring a domain name from a First Registrar 605 to a Second Registrar 24. A Customer 20 may indicate on the Second Registrar's web site that the Customer 20 wants to transfer a domain name from a First Registrar 605, i.e. the currently sponsoring Registrar of record, to a Second Registrar 24. (Step 1100) The domain name with a status flag indicating a transfer request, e.g. pendAuto, and the necessary registration information may be stored in a table in the Internal Database 601. (Step 1101) The table may be a temporary table that is later copied to the Internal Database 601, but is preferably a permanent table written directly to the Internal Database 601. In order to transfer the domain name from the First Registrar 605 to the Second Registrar 24, the Second Registrar needs to verify that the Customer 20 is in fact the registrant, i.e. Customer 20, of the domain name and that the First Registrar 605 is in fact the Registrar of record for the domain name.

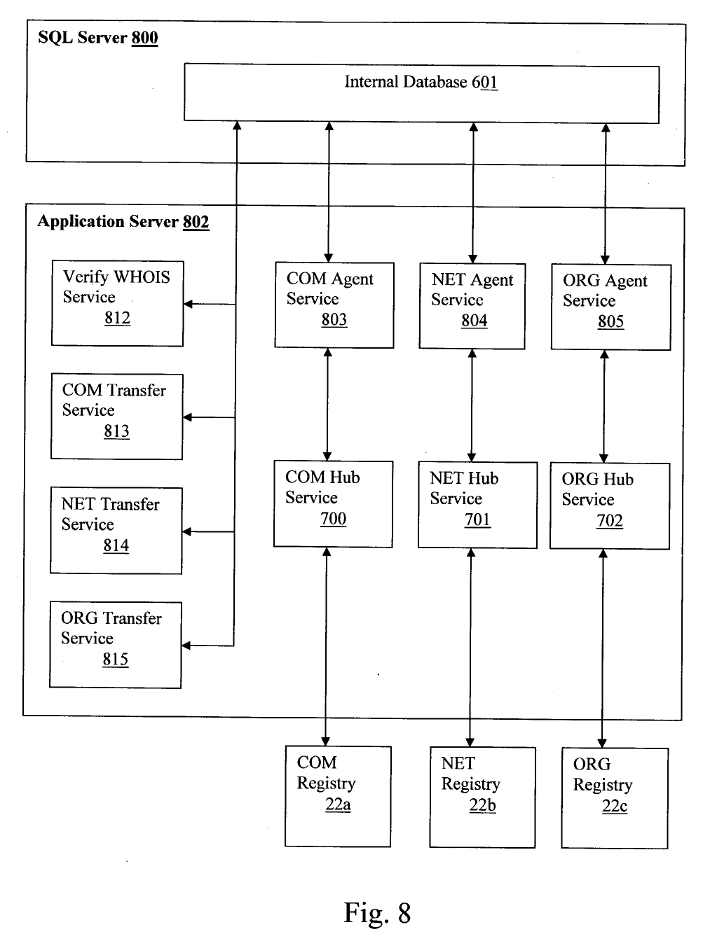

With reference to FIG. 8, a Verify WHOIS Service 812 may be used to automatically verify that the Customer 20 is the registrant of the domain name and that the First Registrar 605 is currently the Registrar of record. The Verify WHOIS Service 812 may accomplish this by monitoring the Internal Database 601 looking for domain names with a status flag indicating a transfer request, e.g. pendAuto. The Verify WHOIS Service 812 may reside on the application server 802. For domain names where a Registrar is the authoritative source for the contact information, e.g. domain names having a TLD of .com, net, org, or .ws, the Verify WHOIS Service 812 may get the Registrar of record and that Registrar's URL from the Registry's port 43 WHOIS. The full WHOIS record is then obtained from the Registrar's URL via port 43. For domain names where the Registry 22 is the authoritative source for the contact information, e.g. a domain name having a TLD of .biz, info, or .us, the Verify WHOIS Service 812 may obtain the full WHOIS record directly from the Registry's WHOIS database.

The Verify WHOIS Service 812 may parse the registrant's name and administrative contact's email address from the full WHOIS record for a comparison to the registrant name and administration email address that the Customer 20 gave the Second Registrar 24 when selecting to transfer the domain name. The Registrant name may be checked for consistency to be sure that a transfer of ownership is not performed at the same time as the transfer from the First Registrar 605 to the Second Registrar 24. The administrative email is checked for consistency because the current administrative contact must approve the transfer before the Registrar 24 can initiate the transfer.

If the administrator's email address is not correct, then the Customer 20 must update the email address at the First Registrar 605 before proceeding. (Step 1102) This prevents an unauthorized person from transferring a domain name from the First Registrar 605 to the Second Registrar 24 without proper authority to do so. The status flag may be set to indicate that the Customer 20 provided information does not match the authoritative source provided information, e.g. a status of pendWhois. A domain name with a status flag of pendWhois may be handled by a manual or automatic processing interface. Depending on what does not match, an appropriate email may be sent to the Customer 20 explaining how to correct the situation. If the Customer 20 corrects the mismatched data, the status flag may once again be set to pendAuto and the Verify WHOIS Service 812 process may be started again.

If the Customer 20 entered registrant name and administrative email match with the authoritative source for the registrant name and administrative email, the status flag of the domain name in the Internal Database 601 may be changed to indicate that the domain name may be transferred, e.g. pendACK. A confirmation email may be sent to the Customer 20 asking the Customer 20 to confirm their intent to transfer the domain name from the First Registrar 605 to the Second Registrar 24. (Step 1103).

One method for the Customer 20 to affirmatively respond to the confirmation email is to allow the Customer 20 to log into a secure area to complete the confirmation. This may be accomplished by inserting a link in the confirmation email so that the Customer 20 may easily access the secure area. In a preferred embodiment, the confirmation email also contains two values that together provide a unique identifier to help the Registrar 24 identify the transfer and ensure that only the recipient of the email at the Administrator's email address is responding. The first value may be the record ID of the transfer. The second value may be a unique key that is generated randomly for each transfer record. The record ID may be used to allow the Registrar 24 to identify the account as well. This adds another layer of security in that if the Customer 20 does not login into the same account in which the transfer purchase was requested, even if the Customer 20 has the correct link for that transfer, the Customer 20 will not be able to confirm or deny the transfer.

If the Customer 20 decides to deny the transfer after logging into the secure area, the transfer is cancelled and the status flag for the domain name is set to indicate this denial, e.g. pendDelete. If the Customer 20 confirms the transfer, the transfer may be moved to the permanent domains table with a status flag indicating a need to initiate a transfer request for this domain name. (Step 1104).

An Agent Service 803-805 for the TLD of the domain name being transferred may be used to detect a domain name in the Internal Database 601 with a status flag indicating that a transfer request for the domain name is needed. The Agent Services 803-805 preferably comprise a software program or thread of a software program that monitors the Internal Database 601 checking for domain names that have a status flag indicating that an action needs to be performed. There is preferably at least one Agent Service 803-805 for every TLD offered by the Registrar 24. The Agent Services 803-805 may reside on the application server 802 and preferably communicate with the Registries 809-811 as needed through connections via dedicated Hub Services 700-702. Multiple instances of an Agent Service 803-805 may be running for any given TLD. For example, two COM Agent Services 803 may be running at the same time due to the volume of .com domain names sponsored that are registered or transferred on a daily basis. The Internal Database 601 is preferably designed to allow thread safe access by multiple instances of the same Agent Service 803-805.

After an Agent Service 803-805 finds a domain name with a status flag indicating a transfer request is needed, the Agent Service 803-805 may send a transfer request to a Registry 22a-c. (Step 1105) The transfer request is preferably sent to a Registry 22a-c via a Hub Service 700-702 that manages the connections for the Registry 22a-c for that particular TLD. If the request is successful, the status flag is changed to indicate the status of waiting for a response. Once the transfer has been initiated, the Registry 22a-c may notify the First Registrar 605 of the transfer request. The First Registrar 605 has 5 days to respond per ICANN rules. The First Registrar 605 may ACK (ACKnowledge) the transfer right away allowing the transfer to be completed quickly, NACK (Not ACKnowledge) the transfer, or do nothing. If the First Registrar 605 does nothing, the Registry 22a-c may ACK the transfer request themselves to the Second Registrar 24 after 5 days. If the request is not successful, the status flag may be changed to indicate this condition depending on the reason the request was not successful. This situation will likely require manual intervention to cure the error and to retry the transfer (set it back to initiate transfer status).

A Transfer Service 813-815 may be used to monitor the appropriate resource to determine when a transfer has been completed or denied. (Step 1106) Transfer Services 813-815 may take various forms, but preferably reside on an application server 802. There may be one or more Transfer Service 813-815 for each TLD or a single Transfer Service may handle one or more TLDs. The Transfer Services 813-815 monitor communications from the Registries regarding transfers to or from a Registrar 24. Once a Registrar 24 has initiated a transfer, the Registrar 24 may rely on a response from the Registry 22a-c to tell the Registrar 24 when the transfer has been completed and when the domain name is now sponsored by the Registrar 24. The Transfer Services 813-815 may also watch for notices from the Registry 22a-c that a request to transfer a domain away from the Second Registrar 24 has been initiated.

The communications from the Registry 22a-c to the Transfer Services 813-815 typically come in the form of an email notification or a daily report. The Transfer Services 813-815 are preferably designed to parse the reports and emails to determine the type of notification being sent to the Registrar 24 and to make the necessary changes in the Internal Database 601 to signal the Agent Services 803-805 to take the appropriate actions.

If the Registry 22a-c notifies the Registrar 24 that the transfer has been completed, the status flag may be changed to indicate this new status. The associated Agent Service 803-805 for the TLD of the domain name may then setup the nameservers and change the status flag to indicate the domain is ok and active. If the Registry 22a-c notifies the Registrar 24 that the transfer has been denied, the status flag may be changed to indicate this new status with an appropriate error message. Once the error has been resolved, either automatically or through manual intervention, the status flag is changed to indicate a transfer request for the domain name should be initiated and the process may be tried again.

It should be noted that in many cases the status flag actually indicates that some type of action needs to be performed. The Agent Services 803-805 continually scan the database for those status flags, picks them up, performs the needed action, and then sets the status flag to a new appropriate value based on the action performed and the results of the action.

In view of the foregoing, it will be understood by those skilled in the art that the systems and processes of the present invention can facilitate the registration of domain names with an accredited Registry via an accredited Registrar's web site. The above-described embodiments have been provided by way of example, and the present invention is not limited to these examples. Multiple variations and modification to the disclosed embodiments will occur, to the extent not mutually exclusive, to those skilled in the art upon consideration of the foregoing description. For example, while specific numbers of TLDs, Hub Services, Agent Services and Transfer Services where shown in the figures, the particular number may be modified based on the needs of the Registrar. Such variations and modifications, however, fall well within the scope of the present invention as set forth in the following claims.

What is claimed is:

1. A system for transferring sponsorship of a domain name previously registered to a registrant from a First Registrar to a Second Registrar, comprising:
A) a web site operated by a Second Registrar having fields for receiving a domain name, domain name transfer request and Customer information from a Customer;
B) an internal database for storing the domain name, the Customer information and an associated status flag indicating the Customer wants to transfer sponsorship of the domain name from a First Registrar to the Second Registrar;
C) a Verify WHOIS Service for verifying the Customer is the registrant of the domain name;
D) an Agent Service for sending a transfer request to an authoritative Registry; and
E) a Transfer Service for receiving a response from the Registry and updating the associated status flag for the domain name in the internal database to reflect the response from the Registry.

2. The system of claim 1, wherein the Customer information includes a registrant name and an administrative email address.

3. The system of claim 1, further comprising:
F) a Hub Service for improving communications between the Agent Service and the Registry.

4. A system for transferring sponsorship of a domain name previously registered to a registrant from a First Registrar to a Second Registrar, comprising:
A) a web site operated by a Second Registrar having fields for receiving a domain name, domain name transfer request and Customer information from a Customer;
B) an internal database for storing the domain name, the Customer information and an associated status flag indicating the Customer wants to transfer sponsorship of the domain name from a First Registrar to the Second Registrar;
C) a first automated process for verifying the Customer is the registrant of the domain name;
D) a second automated process for sending a transfer request to an authoritative Registry; and
E) a third automated process for receiving a response from the Registry and updating the associated status flag for the domain name in the internal database to reflect the response from the Registry.

5. The system of claim 4, wherein the Customer information includes a registrant name and an administrative email address.

6. The system of claim 4, further comprising:
F) a Hub Service for improving communications between the second automated process and the Registry.

7. A system for transferring sponsorship of a domain name previously registered to a registrant from a First Registrar to a Second Registrar, comprising:
A) means for receiving a domain name, domain name transfer request and Customer information from a Customer;
B) means for storing the domain name, the Customer information and an associated status flag indicating the Customer wants to transfer sponsorship of the domain name from a First Registrar to the Second Registrar;
C) means for verifying the Customer is the registrant of the domain name;
D) means for sending a transfer request to one of a plurality of Registries; and
E) means for receiving a response from the Registry and updating the associated status flag for the domain name in the internal database to reflect the response from the Registry.

8. The system of claim 7, wherein the Customer information includes a registrant name and an administrative email address.

9. The system of claim 7, further comprising:
F) means for improving communications between the means for sending a transfer request and one of the pluralities of Registries.

10. The system of claim 7, wherein the means for receiving a domain name include a web site run by the Second Registrar.

11. The system of claim 7, wherein the means for storing the domain name include an internal database.

12. The system of claim 7, wherein the means for verifying the Customer is the registrant of the domain name include a Verify WHOIS Service.

13. The system of claim 7, wherein the means for sending a transfer request to one of a plurality of Registries include an Agent Service.

14. The system of claim 7, wherein the means for receiving a response from the Registry include a Transfer Service.

15. The system of claim 7, wherein the Customer information includes a registrant name and an administrative email address.

16. A process for transferring sponsorship for a domain name registered with an authoritative Registry from a First Registrar to a Second Registrar, comprising the steps of:
A) providing a web site for receiving a domain name, a transfer request, a first registrant's name and a first administrator's email address from a Customer;
B) storing the domain name, an associated status flag indicating a transfer request, the first registrant's name and the first administrator's email address;
C) receiving a second registrant's name and a second administrator's email address from an authoritative source;
D) comparing the first registrant's name with the second registrant's name and comparing the first administrator's email address to the second administrator's email address;
E) if the first and the second registrant's name or the first and the second administrator's email address did not match in Step D), preventing the Customer from continuing with transferring sponsorship of the domain name until the mismatch has been corrected;
F) if the first and the second registrant's name or the first and the second administrator's email address did match in Step D), sending an acceptance email to the verified Customer;
G) receiving a confirmation from the Customer that the Customer still wants to transfer sponsorship of the domain name;
H) sending a transfer request to an authoritative Registry;
I) receiving a response from the Registry; and
J) updating the associated status flag to reflect the response from the Registry.

17. The process of claim 16, where in the first registrant's name, first administrator's email address and the status flag are stored in an internal database.

18. The process of claim 16, further comprises the step of sending a rejection email to the Customer regarding the mismatch during step E).

19. The process of claim 16, wherein the response from the Registry is an acknowledgement of the transfer of sponsorship and the updating the associated status flag includes setting the status flag to indicate the domain name is now active with the Second Registrar.

20. The process of claim 16, wherein the acceptance email sent to the Customer includes a key that is required for the Customer to provide the confirmation in step E).

21. The process of claim 20, wherein the key provides access to a secure area in the web site where the Customer may enter the confirmation for step G).

22. The process of claim 20, wherein the key includes a random number that must be entered into the web site by the Customer.

23. The process of claim 20, wherein the key includes a number associated with a login account where the Customer entered the transfer request in the web site and where the Customer must login into again to enter the confirmation for step G).
